(19) United States
(12) Patent Application Publication
(10) Pub. No.: US 2001/0006745 A1
(43) Pub. Date: Jul. 5, 2001

(54) Bipolar collector for fuel cell

(75) Inventors: Guy Bronoel, Versailles (FR); Serge Besse, Ivry sur Seine (FR); Jean-Francois Pauvarque, Paris (FR)

Correspondence Address: HENDERSON & STURM LLP, 206 Sixth Avenue, Suite 1213, Des Moines, IA, 50309-4076, US

(73) Assignee: SORAPEC

(21) Appl. No.: 09/760,960

(22) Filed: Jan. 16, 2001

Related U.S. Application Data
(63) Continuation of application No. PCT/FR98/02149, filed on Oct. 8, 1998.

(30) Foreign Application Priority Data
Jul. 21, 1998 (FR) 98.009236

(51) Int. Cl. H01M 8/10; H01M 8/24

(52) U.S. Cl. 429/32; 429/34; 429/35

(57) ABSTRACT

The invention concerns a bipolar collector for a solid polymer electrolyte fuel cell whereof the electronic conduction is provided by uniformly distributed metal cylinders, and whereof the tips penetrate into the electrodes. The minimal distance between two cylinders ranges between 2 and 4 mm and the tightness between the two surfaces is provided by a polymer plate wherein the cylinders are inserted. Said design is applicable to plates incorporating ducts for transporting fluids or plates whereon are arranged, on either side, microporous structures serving as fluid distributor. Said type of collector is characterised in that the ohmic drop is very low, even for current density levels of the order of 1 A/cm2.

The present invention relates to a bipolar collector for a fuel cell with a solid polymer electrolyte, characterised in that the electronic conduction from one face to the other is undertaken by metal cylinders distributed in a regular fashion and whose ends penetrate the electrodes, the minimum distance between the cylinders is between 2 and 4 mm and the seal between the two faces is provided by a polymer plate in which said cylinders are inserted symmetrically.

In the last 10 years, great progress has been made in the field of fuel cells comprising a solid polymer electrolyte, particularly as regards the activity of the electrodes; thus, high-performance electrodes-electrolyte assemblies are available today whose mass per unit area is of the order of 80 mg/cm².

In its most traditional version, the connection between the various unit elements (collection of the electrical charges and distribution of the gases on the surface of the electrodes) is undertaken by collectors of ribbed compact graphite whose mass per unit area is of the order of 750 mg/cm², namely a value 10 times higher than that of the active unit composed of electrodes and associated membrane.

Furthermore, since collectors with an area of several dm² are involved, the machining operations required to produce a complex network of channels on each face of the compact graphite collector are extremely delicate and hence very expensive.

For some years, research has been conducted in order to find a substitute for such compact graphite collectors. Among the various solutions envisaged, that which consists in the use of polymers rendered conductive by the addition of a charge of graphite powder permits the formation of the channels during the casting of the material and thus permits the obtaining of collectors of a greatly reduced cost compared with that of graphite collectors.

Allowing for a path length for the transfer of the charges of the order of 2 to 3 mm (range of thickness of the collectors for fuel cells), it is suitable, for electrodes able to work with current densities up to values of 1 A/cm², to use a composite material whose resistivity will be not more than 10⁻² Ω.cm in order that the voltage drop is limited to only a few millivolts. Said resistivity value means high contents of graphite in the graphite/polymer composite, which may lead on the one hand to mechanical fragility of the plate and on the other to a moderate lightening (about 600 mg/cm² instead of 750 mg/cm²)

Another approach also considered consists in using metal collectors. A substantial lightening may be obtained in this way by using aluminium or titanium alloy strips for which the channels are easily obtained by embossing. Unfortunately, a protection of the surface of such materials is necessary in order to prevent the formation of an oxide film which would induce a high resistance in the circuit.

The use of certain stainless steel has also been considered, but here again, for an operation of long duration and with high current density, it is suitable to protect their surface by a coating such as titanium nitride. Such surface protection measures remain expensive, in fact, and they result in a cost which is still too high even if a significant lightening of the collectors is obtained.

The aim of the present invention is the production of a novel bipolar collector for a fuel cell enabling the above-mentioned drawbacks to be overcome; the collector described possesses excellent conductivity, thus permitting the operation of the fuel cell with high current densities, a moderately low mass and a low operational cost.

The collector provided by the present invention is characterised in that the major part of its volume is composed of a compact and/or cellular polymer and that the electronic conduction is undertaken by small metal cylinders passing right through the collector at right angles to its surface.

According to a first characteristic of the present invention, the bipolar collector comprises, on each of its faces, channels performing the transport of the fluids; according to said characteristic, the metal cylinders are disposed on the collector in the parts in relief between two channels, their regular distribution being undertaken according to a square or rectangular pattern.

According to a second characteristic of the invention, the transport of the fluids is not performed by the collector but by means a macroporous structure such as a foam, a woven fabric or any other open-cell structure; the electronic conduction is in this case likewise performed by metal cylinders passing through the polymer plate, the regular layout of said cylinders being able in this case to be provided according to an equilateral triangular pattern.

According to any one of the two above-mentioned characteristics of the invention, the diameter of the metal cylinders is mainly defined by their method of mounting in the polymer material and by their mechanical characteristics. In the case of the use of cylinders of stainless steel of the 316L type, a diameter between 0.1 and 0.3 mm, preferably 0.2 mm, is sufficient.

According to any one of the two above-mentioned characteristics of the invention, the cylinders have a length such that after tightening of the collector (possible macroporous structure)-electrodes unit, they pass right through the polymer plate by a height of between 0.1 and 0.3 mm; said emergent ends penetrate the electrodes.

According to any one of the two above-mentioned characteristics of the invention, the part of the cylinders penetrating the electrodes is covered with a thin film coating of precious metals such as gold or platinoids, said coating being able to be undertaken by cathodic coating.

Other characteristics and advantages of the invention will appear more clearly from a reading of the description below with reference to the attached figures which represent respectively:

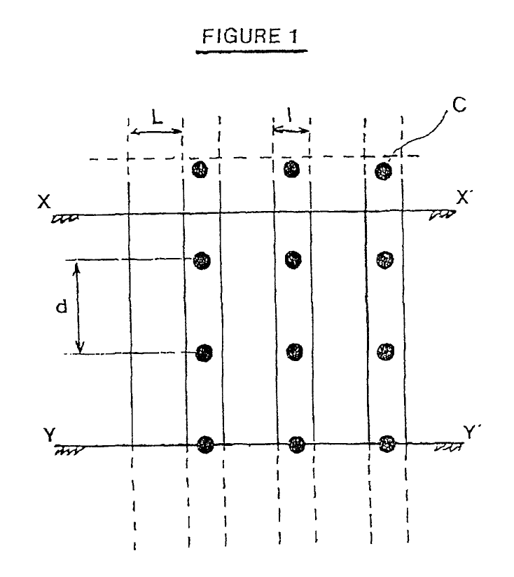

FIG. 1, a front view of the ribbed bipolar collector according to a first characteristic of the invention comprising channels enabling the transport of the fluids to be performed,

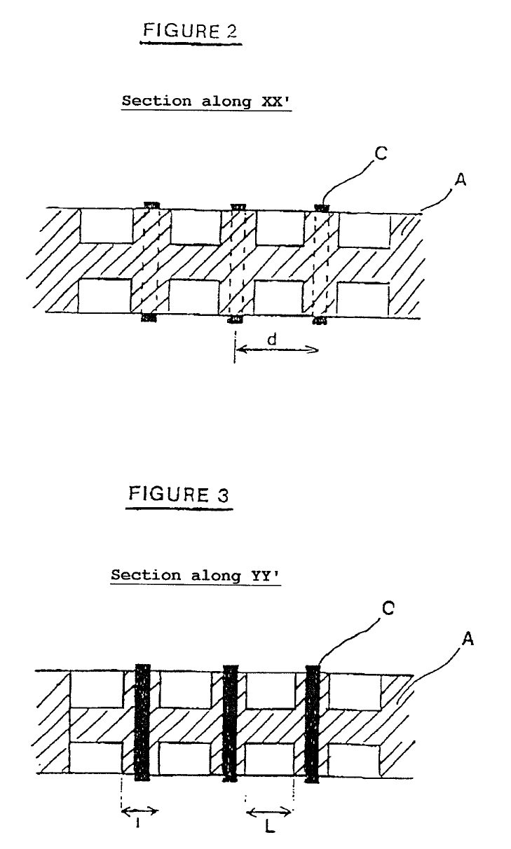

FIG. 2, a section along the axis X-X′ of the ribbed bipolar collector according to a first characteristic of the invention, said section being undertaken at a place not comprising metal cylinders,

FIG. 3, a section along the axis Y-Y′ of the ribbed bipolar collector according to a first characteristic of the invention, said section being undertaken at a place comprising the metal cylinders,

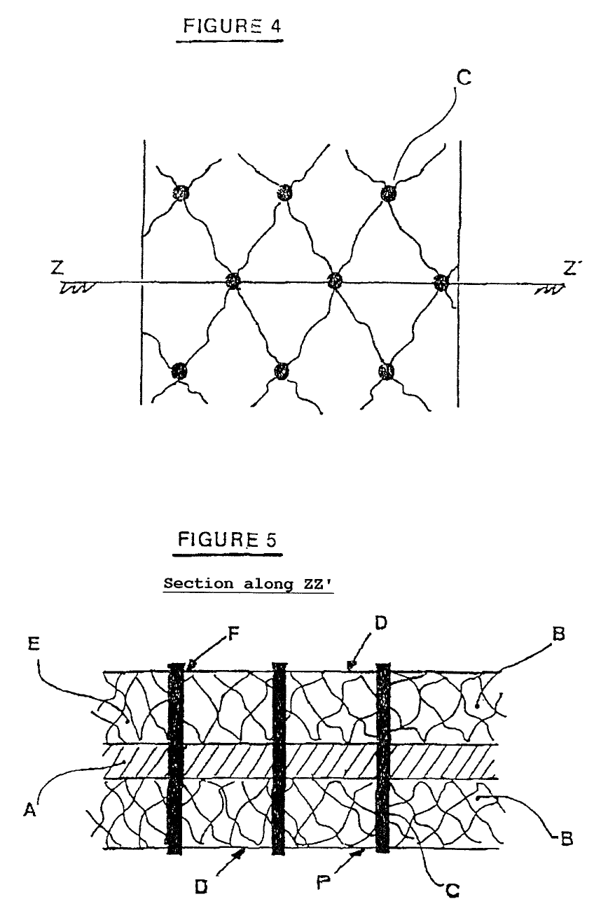

FIG. 4, a front view of the bipolar collector according to a second characteristic of the invention,

FIG. 5, a section along the axis Z-Z′ of the bipolar collector and of the macroporous structure according to a second characteristic of the invention.

According to the invention, the distribution of the cylinders or needles must be such that the drainage of the channels is if possible uniform over the whole surface of the collector. The distance between each conductive cylinder is determined by the maximum ohmic drop which it is desired to obtain for a given apparent current density.

FIGS. 1 to 3 represent the collector according to a first characteristic of the invention, for which the polymer plate (A) comprises two channels performing the transport of the fluids. If “1” is defined as being the width of a channel and “L” the distance between two channels, that is to say the surfaces (crests) in contact with the electrodes, the metal cylinders (C) are disposed on said crests and will have preferably an axial distance (d) which will be equal to d=1÷L, the distribution of the conductive cylinders being effected according to a square pattern (FIG. 1).

It is shown that, for a square distribution of the cylinders, the ohmic drop is of the form:

$$Δ V = \frac{i \cdot {d}^{2} \cdot ρ}{4 \cdot e}$$

where i is the mean current density per cm² of visible surface of electrode

ρ is the transverse resistivity of the electrode

e is its thickness.

Knowing that, for high-performance electrodes, the measured values of the term ρ/e are of the order of 0.45 Ω, it follows that the distance d will have to be less than 3 mm in order that ΔV is less than 10 mV with i=1 A/cm².

As regards the ohmic drop in the metal cylinders, it is obvious that it remains negligible compared with the above-mentioned transverse ohmic drop. Thus, assuming (d) is equal to 3 mm and knowing that the current passing through each cylinder corresponds to the area d², it is shown that, for a current density equal to 1 A/cm², the ohmic drop for a length of the cylinder of 4 mm will be of the order of 1 mV (1.15 mV). Said value is 10 times weaker than the transverse ohmic drop, for a cylinder of diameter 0.2 mm and whose material constituting it has a resistivity ρm of 10⁻⁵ Ω cm.

Knowing that the operating current densities of the fuel cells are generally between 0.3 and 1 A/cm², the distance (d) between two cylinders will have to be between 2 and 4 mm in order that the ohmic drop in the electrode is less than 10 mV.

Let us consider the case where d=2.5 mm, if the values of ρ/e, ρ− and of the diameter of the cylinders remain identical to those given previously, the ohmic drop will assume, for a current density equal to 1 A/cm², a value of:

total ΔV=7.10⁻³ V

The mean mass per unit area of the collector according to the present invention is likewise very attractive compared with that of traditional bipolar collectors. Indeed, if it is considered that each cylinder is combined with an area element d² and that the profile of the conductor is as represented in FIG. 3, it is shown that for a polymer of density 1 and a metal element of density 7.5, the mean density of the composite material is of the order of 1.06. It follows that the collector according to a first characteristic of the invention has conductive properties at least identical to those of the collectors of compact graphite or of charged polymer, its mass being, to within 6%, that of the polymer constituting the bulk of the volume.

It has been observed that the electric contacts with the electrodes were improved when the conductive cylinders protruded 0.1 to 0.3 mm beyond the plane of the collector, as shown in FIG. 3. Consequently, in order to preserve a contact resistance as weak as possible at the interfaces of the electrodes and the conductive cylinders when the latter are of stainless steel, it is suitable to protect their emergent surfaces by a coating, for example based on platinoids or gold. This operation is possible at a reasonable cost, since the collectors according to the invention are characterised on the one hand by a small emergent surface compared with their frontal surface and on the other by a very precise positioning of the surfaces to be protected.

Thus, for a layout such as that shown in FIG. 3, where (d) is equal to 2.25 mm and the diameter of the cylinders is equal to 0.2 mm with an emergent part of 0.1 mm compared with the faces of the collector, it is shown that the total surface to be protected of the metal collector represents only 3.7% of the frontal visible surface of the electrode which is associated with it.

With a power density of 250 mW/cm², it is therefore found that the total surface to be protected is about 150 cm² per kW. In such conditions, a coating with gold of 1 μm thickness would lead to a gold mass of 0.3 g/kW, a negligible extra cost compared with the cost of the kW.

Coating with platinoids or gold is easily achievable by the so-called “brush plating” process. In this process, each cylinder is placed in contact with a porous body impregnated with the electrolyte containing the metal or metals to be electroplated. Such cylinders are polarised cathodically by their other emergent end. Thus, it is possible to provide a coating of controlled thickness only on the emergent parts of the cylinders, avoiding an excessive loss of precious metals.

According to a second characteristic of the invention for which the transfer of the fluids is performed by means of a macroporous structure such as a foam, a woven fabric or any open-cell structure, the same principle of electronic conduction by metal cylinders is utilised.

FIG. 4 represents a front view of a collector according to the invention and FIG. 5 a section of the same collector along Z-Z′. The collector is composed of a polymer plate (A) whose thickness may be between 0.5 and 2 mm depending on the nature of the material, the size of the plate and its mode of operation.

On each side of the plate are placed macroporous structures (B) which permit the lateral circulation of the fluids. Said macroporous structures may be of polymer, metal or metal alloy.

In the case of the metal structures, it is suitable that their visible surface is covered with a protective film preventing the corrosion of the metal or the alloy in the operating conditions of the cell, the protective film having a hydrophobic character facilitating the removal of water.

The macroporous structures may be integral with the plate (A) or simply pressed onto the latter. Their thickness depends on their shape, on their characteristics in terms of pressure loss and on the size of the collectors and the currents produced. They are designed to resist a tightening pressure of the electrodes such that their thickness (E) after tightening is clearly defined.

In said conditions, the electrodes bear upon the planes (D); the conductive cylinders (C), which pass symmetrically through the plate (A), have a length such that after tightening of the electrodes on the external planes (D) of the macroporous structures, they protrude beyond the plane (D) at (F) by a length between 0.1 and 0.3 mm.

According to a characteristic of the invention, pins (not shown in FIG. 5) are disposed at right angles to the surface of the plate (A), their height defining the spacing between the face of the electrode and the surface of the plate.

It is suitable that the distribution of the cylinders is uniform in order that the drainage of the charges is homogeneous and that the transverse ohmic drop in the electrode is acceptable. The absence of channels makes a distribution according to equilateral triangles possible; this arrangement leads to a weaker ohmic drop than for an arrangement with square patterns, since:

$$Δ V = \frac{i \cdot {d}^{2} \cdot ρ}{6 \cdot e}$$

where d is the axial distance of the conductive cylinders distributed according to a pattern of the equilateral triangular type such as that shown in FIG. 4.

As in the case of the plates comprising channels, the tips of the conductive cylinders or needles penetrating the electrodes must be protected by a surface coating in order to prevent any corrosion or passivation. Conversely, the surface lying between the plane (D) and the plate (A) has no need to be protected to the extent that the constituent material is a stainless steel, for example of the 316L type. Thus, the surfaces in contact with the electrodes are conductive and the remainder of the surface of the cylinder is covered with a passivation layer.

The protection of the tips of the cylinders may be brought about as described above, namely by a “brush electrolysis” leading to coating with a very fine layer of precious metal.

The following example of the execution of a bipolar collector according to the invention made it possible to verify the attractiveness of the proposed concept experimentally. A collector with a visible surface of approximately 50 cm² (7 cm×7 cm) was created.

The collector is created from a plate whose composition is based on aromatic polyesters of the polybutylene terephthalate type reinforced by glass fibres of 1 mm thickness, in which have been inserted, according to a triangular pattern, 600 stainless steel cylinders having a length of 4.2 mm. The plate studding operation was carried out at a temperature of 100° C., thus permitting the hardness of the polymer to be reduced.

In the collector example executed, the distance between the cylinders is of the order of 3 mm; the mounting used to introduce the cylinders into the polymer plate is such that the emergent part of the cylinders on either side of the plate is identical for all the cylinders to within 10 μm. After the positioning of the cylinders, the unit is placed in a mould containing an impression of the emergent parts and is heated to a temperature slightly less than the melting temperature of the polymer in order that the contacts between the metal conductors and the polymer are optimised.

After this operation, a polypropylene plate containing holes for the passage of the conductive cylinders is arranged on one of the faces of the collector, allowing the ends to protrude by 0.1 mm. The emergent parts of the cylinders are connected electrically to a cathodically polarised metal plate and placed in contact with a felt impregnated with an electrolysis solution based on potassium gold cyanide, the felt being likewise placed in contact with an anodically polarised metal plate. The current and the temperature are adjusted in order that about 1 μm of gold is deposited on the tips of the cylinders. The same electrolysis operation is carried out on the tips of the cylinders situated on the other side of the collector.

After the protection treatment carried out at the two ends of the conductive cylinders, there is placed on each face of the collector an open-cell structure based on polysulfone, which plays the role of distributor for the fluids feeding and/or leaving the electrodes. This structure, after tightening, has a thickness of 1.5 mm and allows the tips of the cylinders to protrude by 0.1 mm.

Two assemblies comprising E-TEX® electrodes (“standard ELAT electrode”) combined with a membrane of the NAFION® type were pressed on either side of said structure and fed with hydrogen and air. Under a total voltage of 1.45 V, an apparent current density of 0.3 A/cm² was observed. The measurement of the ohmic drop is effected by the so-called “current interruption” method or “circuit breaker method”; it enables the voltage drop in the electrolytic membrane to be evaluated. There may then be deduced from this the value of the ohmic drop in the collector according to the invention. The latter is evaluated at about 5 mV. This experiment therefore validates the concept presented.

The modes of execution utilisable for the positioning of the metal conductors in the polymer structure are numerous: insertion of the cylinders during the casting of the polymer plate, studding, stitching by means of a stainless steel wire, then abrasion of the strips of wires, insertion of hot wires, etc. Said operations may be carried out, depending on the nature of the polymer, either in the cold state or at a temperature slightly lower than the melting point of the polymer.

All in all, the invention is not limited to the preceding description, but covers all variants of it.

As regards the choice of the nature of the polymer which makes up the bulk of the collector, it is suitable to satisfy the following conditions:

good mechanical behaviour of the material, preferably up to temperatures of 150° C.,

good physico-chemical behaviour in an oxidising atmosphere in the presence of water vapour or condensates capable of including acid traces,

good adherence between the polymer and the metal or metal alloy constituting the conductive cylinders.

In these conditions, the use of polymers belonging to the following families may be recommended: polysulfone, polyphenylene sulfide, polycarbonate, acrylonitrile/butadiene/styrene (ABS), crosslinked acrylic polyesters charged with glass fibres, aromatic polyesters such as polyethylene terephthalate or polybutylene terephthalate reinforced with glass fibres.

1. Bipolar collector for a fuel cell with a solid polymer electrolyte, characterised in that the electronic conduction from one face to the other is undertaken by metal cylinders distributed in a regular fashion and whose ends penetrate the electrodes, the minimum distance between the cylinders being comprised between 2 and 4 mm and the seal between the two faces of the collector being effected by a polymer plate in which said cylinders are inserted symmetrically.

2. Bipolar collector according to claim 1, characterised in that the polymer plate comprises, on its two faces, channels for the transport of the fluids.

3. Bipolar collector according to claims 1 and 2, characterised in that the metal cylinders are placed in the plate in the parts in relief between two channels, their regular distribution being effected according to a square or rectangular pattern.

4. Bipolar collector according to claim 3, characterised in that the cylinders have a diameter between 0.1 and 0.3 mm and are composed of stainless steel.

5. Bipolar collector according to claim 3, characterised in that the cylinders protrude on either side of the surface of the polymer plate by a height between 0.1 and 0.3 mm.

6. Bipolar collector according to claim 1, characterised in that the polymer plate does not contain channels for the transport of the fluids but optionally some pins whose height on each face defines the spacing between the face of each electrode and the surface of the polymer plate.

7. Bipolar collector according to claim 6, characterised in that the space existing between the plane of the electrode and the surface of the polymer plate is occupied by a macroporous structure which permits the transport and the good distribution of the fluids.

8. Bipolar collector according to claim 7, characterised in that the macroporous structure is composed of a metal or a metal alloy whose visible surface is coated with a protective film preventing its corrosion in the operating conditions of the cell and whose hydrophobic character facilitates the removal of water.

9. Bipolar collector according to claim 7, characterised in that the macroporous structure is composed of a polymer.

10. Bipolar collector according to claims 6 and 7, characterised in that the cylinders pass through the plate and are disposed regularly according to an equilateral triangular pattern.

11. Bipolar collector according to claim 10, characterised in that the cylinders have a diameter between 0.1 and 0.3 mm and are composed of stainless steel.

12. Bipolar collector according to claim 10, characterised in that the cylinders have a length such that after tightening of the electrodes on the external planes of the macroporous structures, they protrude beyond said planes by a length between 0.1 and 0.3 mm.

13. Bipolar collector according to claims 5 and 12, characterised in that the part of the cylinders which protrudes beyond the polymer plate and penetrates the electrodes is covered with a thin layer coating of precious metals such as gold or platinoids.

14. Bipolar collector according to claim 13, characterised in that the coating of precious metals on the ends of the cylinders is effected by cathodic coating.

15. Bipolar collector according to claim 1, characterised in that the polymer of the plate is chosen from among compounds of the following type: polysulfone, polyphenylene sulfide, polycarbonate, acrylonitrile/butadiene/styrene, crosslinked acrylic polyesters charged with glass fibres, aromatic polyesters such as polyethylene terephthalate or polybutylene terephthalate reinforced with glass fibres.

16. Bipolar collector according to claim 1, characterised in that the insertion of the cylinders into the polymer plate is effected during the casting of the polymer.

17. Bipolar collector according to claim 1, characterised in that the insertion of the cylinders into the polymer plate is effected by a mechanical operation after the manufacture of the plate, inter alia studding or stitching by means of a stainless steel wire.
